(19) United States
(12) Patent Application Publication
(10) Pub. No.: US 2004/0179729 A1
(43) Pub. Date: Sep. 16, 2004

(54) Measurement system

(75) Inventors: Shigeaki Imai, Uji-Shi (JP); Koji Fujiwara, Mishima-Gun (JP); Makoto Miyazaki, Ibaraki-Shi (JP); Naoki Kubo, Nishinomiya-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/620,729

(22) Filed: Jul. 16, 2003

(30) Foreign Application Priority Data
Mar. 13, 2003 (JP) 2003-068290

(51) Int. Cl. G06K 9/00

(52) U.S. Cl. 382/154

(57) ABSTRACT

A measurement system is provided in which optimum measurement is conducted depending on an environmental change and movement of an object. The measurement system for measuring an object based on images obtained by plural cameras includes a positional control portion for controlling positions of the cameras to change photographing directions of the cameras, a two-dimensional measurement portion for conducting two-dimensional measurement of the object based on the image of the object, the image being obtained by at least one of the cameras, a stereoscopic measurement portion for conducting stereoscopic measurement of the object based on the images of the object, the images being obtained by the cameras, and a switching portion for switching between the two-dimensional measurement portion and the stereoscopic measurement portion to perform an operation.

This application is based on Japanese Patent Application No. 2003-068290 filed on Mar. 13, 2003, the contents of which are hereby incorporated by reference.

### BACKGROUND OF THE INVENTION

1. Field of the Invention

The present invention relates to a measurement system for measuring an object based on images obtained by plural cameras.

2. Description of the Prior Art

Conventionally, various techniques of stereoscopic measurement using plural cameras are proposed. For example, there is proposed a technique in which two cameras are used to determine a distance away from an object to switch between a low velocity/high accuracy mode and a high velocity/low accuracy mode depending on the distance (Japanese unexamined patent publication No. 8-219774). Further, there is also proposed a technique in which two cameras are used to photograph an object to detect an intruder by the stereoscopic measurement (Japanese unexamined patent publication No. 2000-115810).

In recent years, application of the stereoscopic measurement to a real-time system such as a robot or a monitoring system has been expected with improvement in quality of an image pickup device (an image sensor) and a processor and price-reduction thereof.

One problem in the application of the stereoscopic measurement to a real-time system is how a trade-off between output throughput of three-dimensional data, i.e., processing speed and measurement accuracy is set. An option for the problem is to design equipment in a manner to satisfy “both” critical specifications of throughput and accuracy, both of which are required by the system. However, in order to satisfy theses incompatible requested specifications “at the same time”, a problem arises in which the equipment becomes expensive.

However, there are many systems in which these requested specifications are not necessarily satisfied at the same time and plural measurement modes having different specifications may be switched depending on purpose, the measurement modes being prepared in advance.

In a monitoring system, for example, an object is an intruder or the like. In the system, detection with a high update rate and moderate reliability is required at a normal stage for detecting the intruder, while detection with higher degree of reliability is required at a stage for checking the detected intruder even if it takes some time. In a robot navigation system, when a robot is actuated or stationary, it is necessary to measure a three-dimensional environment around the robot with high degree of accuracy, however, a real-time feature is not so required. When the robot is moving, it is necessary to detect obstacles in real time even if the accuracy is reduced somewhat.

Related Patent Publication 1:

Japanese unexamined patent publication No. 8-219774

Related Patent Publication 2:

Japanese unexamined patent publication No. 2000-115810

### SUMMARY OF THE INVENTION

It is an object of the present invention to provide a measurement system that can conduct optimum measurement depending on environmental changes or movement of an object in a robot or a monitoring system.

According to one aspect of the present invention, a measurement system for measuring an object based on images obtained by plural cameras includes a positional control portion for controlling positions of the cameras to change photographing directions of the cameras, a two-dimensional measurement portion for conducting two-dimensional measurement of the object based on the image of the object, the image being obtained by at least one of the cameras a stereoscopic measurement portion for conducting stereoscopic measurement of the object based on the images of the object, the images being obtained by the cameras, and a switching portion for switching between the two-dimensional measurement portion and the stereoscopic measurement portion to perform an operation.

The positions of the cameras may be individually controlled. Alternatively, the positional relationship between the cameras may be fixed, and, the two cameras are made a group of cameras for performing position control.

Preferably, the positional control portion controls the positions of the cameras so that the cameras photograph ranges differing from each other and face directions differing from each other when the two-dimensional measurement portion conducts two-dimensional measurement, and controls the positions of the cameras so that the cameras photograph an overlapping range when the stereoscopic measurement portion conducts stereoscopic measurement, the overlapping range including the object, and the switching portion switches to operate the two-dimensional measurement portion in an initial condition, and switches to operate the stereoscopic measurement portion when the two-dimensional measurement portion detects a moving object.

Further, the stereoscopic measurement portion includes a portion for reducing resolution of the images, and switches between generation of three-dimensional data with high resolution and generation of three-dimensional data with low resolution appropriately to conduct stereoscopic measurement.

Furthermore, each of the cameras includes an image pickup device in which a color filter having any one of three primary colors is arranged for each pixel, and when image data obtained by the cameras are processed, image data of pixels corresponding to only a color filter with a particular color in the image pickup device of each of the cameras are used.

These and other characteristics and objects of the present invention will become more apparent by the following descriptions of embodiments with reference to drawings.

### BRIEF DESCRIPTION OF THE DRAWING

FIG. 1 shows a structure of a monitoring system according to a first embodiment of the present invention.

FIG. 2 is a block diagram showing an example of a structure of a two-dimensional processing portion.

FIG. 3 is a block diagram showing an example of a structure of a stereo processing portion.

FIG. 4 is a block diagram showing a structure of a modified two-dimensional processing portion.

FIG. 5 is a block diagram showing a structure of a modified stereo processing portion.

FIG. 6 shows a structure of a robot control system according to a second embodiment of the present invention.

FIG. 7 is a block diagram showing a portion of an image input circuit.

FIG. 8 shows a part of pixels of an image pickup device.

FIG. 9 shows an example of a state in which a signal is allocated to each pixel.

### DESCRIPTION OF THE PREFERRED EMBODIMENTS

### First Embodiment

An application example of a measurement system according to the present invention to a monitoring system for security is explained below.

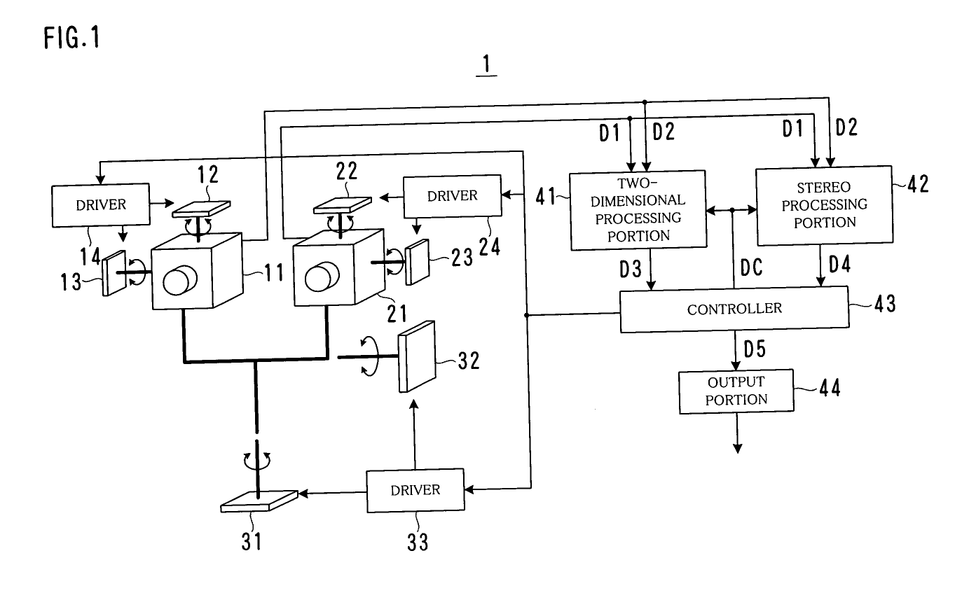

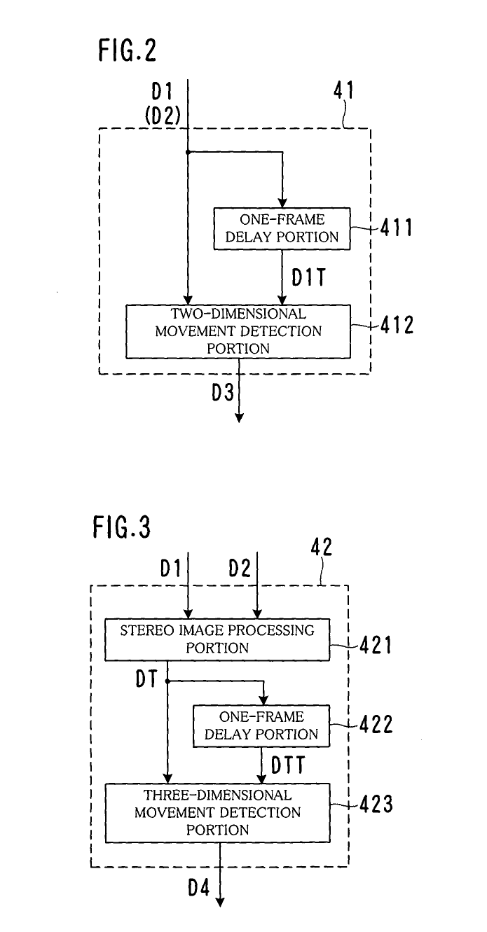

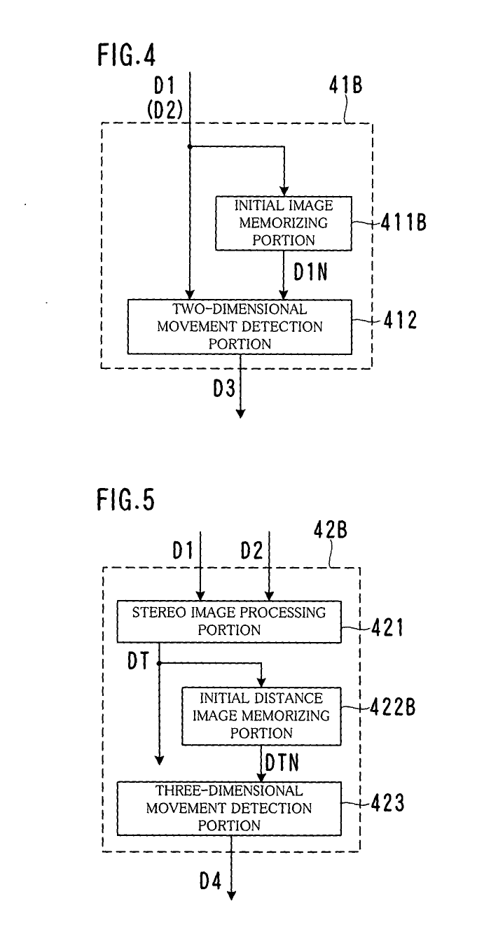

FIG. 1 shows a structure of a monitoring system 1 according to a first embodiment of the present invention. FIG. 2 is a block diagram showing an example of a structure of a two-dimensional processing portion 41, FIG. 3 is a block diagram showing an example of a structure of a stereo processing portion 42, FIG. 4 is a block diagram showing a structure of a modified two-dimensional processing portion 41B and FIG. 5 is a block diagram showing a structure of a modified stereo processing portion 42B.

As shown in FIG. 1, the monitoring system 1 includes two cameras 11 and 21, a pan mechanism 12 and a tilt mechanism 13 that are used for changing the photographing direction of the camera 11, a pan mechanism 22 and a tilt mechanism 23 that are used for changing the photographing direction of the camera 21, a driver 14 for controlling the pan mechanism 12 and the tilt mechanism 13, a driver 24 for controlling the pan mechanism 22 and the tilt mechanism 23, positional control mechanisms 31 and 32, a driver 33 for controlling the positional control mechanisms 31 and 32, a two-dimensional processing portion 41, a stereo processing portion 42, a controller 43 and an output portion 44.

Each of the cameras 11 and 21 includes an optical system, an image pickup device, a zoom mechanism and a drive circuit therefor. Each of the cameras 11 and 21 photographs an area with a predetermined range (an area to be shot) depending on a zooming operation using the image pickup device. The shot image may be an image of a background within the area to be shot or an image of an object to be shot (an object). Data of one frame are output out of the obtained image data at an appropriate cycle. For example, 30 frames as image data per second are output. Further, a signal from outside enables control of a zooming operation or others. The structure and the operation of each of the cameras 11 and 21 per se are conventionally known.

The pan mechanisms 12 and 22 rotate the cameras 11 and 21 from side to side respectively, thereby leading to the swing of the optical axis of each of the cameras 11 and 21 from side to side. The tilt mechanisms 13 and 23 rotate the cameras 11 and 21 up and down respectively, thereby leading to the swing of the optical axis of each of the cameras 11 and 21 up and down. The drivers 14 and 24 control drive of the pan mechanisms 12 and 22 as well as the tilt mechanisms 13 and 23 based on command signals from the controller 43.

The positional control mechanisms 31 and 32 control the entire position and posture of the cameras 11 and 21 including the pan mechanisms 12 and 22 and the tilt mechanisms 13 and 23. Stated differently, the operation of the positional control mechanisms 31 and 32 changes the entire position and posture of the cameras 11 and 21 with the positional relationship between the cameras 11 and 21 being maintained. The driver 33 controls drive of the positional control mechanisms 31 and 32 based on command signals from the controller 43.

The cameras 11 and 21, and the positional control mechanism therefor are so installed that a target area for monitoring in an entrance of a building, an entrance of a room, a corridor, a lobby, a reception desk or a warehouse is included in an angle of view.

Based on each of the images (image data) D1 and D2 obtained by the cameras 11 and 21, the two-dimensional processing portion 41 performs processing for two-dimensional measurement of the object individually to output measurement data D3.

Referring to FIG. 2, the two-dimensional processing portion 41 includes a one-frame delay portion 411 and a two-dimensional movement detection portion 412. The one-frame delay portion 411 memorizes one frame of the image D1 or D2 to output the memorized image D1 or D2 with one frame being delayed. The two-dimensional movement detection portion 412 compares the image D1 or D2 of the current frame with image D1T or D2T in which one frame is delayed, then to detect the object based on a change seen in the comparison result.

As a technique for detecting an object, for example, it is possible to employ a well-known technique such as a technique using background subtraction, a technique using time subtraction or a technique using movement vectors of time-series images (an optical flow technique). In the case of the technique using time subtraction, for example, a subtraction image between the current frame image and the previous frame image is derived by computing, and preliminary judgment is made that an object is present when the sum of intensity of the subtraction images is a threshold level or more. On this occasion, the processing is simple and high-speed processing is possible. However, there is a possibility that even variation in illumination, i.e., brightness in the frame, the presence or absence of shadow and size of the shadow may be detected as an object.

Based on the images D1 and D2 obtained by the cameras 11 and 21, the stereo processing portion 42 performs processing for stereoscopic measurement of the object to output measurement data D4.

Referring to FIG. 3, the stereo processing portion 42 includes a stereo image processing portion 421, a one-frame delay portion 422 and a three-dimensional movement detection portion 423. The stereo image processing portion 421 generates a distance image (three-dimensional data) DT based on the two images D1 and D2 using the triangulation principle. The one-frame delay portion 422 memorizes one frame of the distance image DT to output the memorized distance image DT with one frame being delayed. The three-dimensional movement detection portion 423 compares the distance image DT output from the stereo image processing portion 421 with a distance image DTT in which one frame is delayed, then to detect the detailed status of the object based on a change seen in the comparison result.

More specifically, one of the cameras 11 and 21 is made a reference camera and the other is made a referred camera. The stereo image processing portion 421 searches corresponding points between the image D1 taken by the reference camera (reference image) and the image D2 taken by the referred camera (referred image). The distance image DT is calculated in connection with each pixel in the reference image based on optical parameters corrected beforehand and the positional relationship between the two cameras. In this case, since the processing is complicated, the processing rate is low. However, there is little possibility that variation in illumination may affect detection of an object.

The three-dimensional movement detection portion 423 derives a subtraction distance image between the distance image DT of the current frame and the distance image DTT of the previous frame by computing, and definitive judgment is rendered that an object is actually present when the sum of intensity of the subtraction distance images is a threshold level or more.

In the case of using the monitoring system 1 for security, the two-dimensional processing portion 41 detects, for example, an intruder as the object based on the two images D1 and D2 obtained by shooting ranges differing from each other. In accordance with the position and posture of each of the cameras 11 and 21, and the position and size of the object seen in the images D1 and D2, the two-dimensional processing portion 41 outputs information of a rough position of the intruder and rough size thereof to the controller 43 as the measurement data D3. The controller 43 controls the position, the posture and the zooming operation of each of the cameras 11 and 21 so that the intruder can be zoomed in. The stereo processing portion 42 conducts three-dimensional measurement based on the images D1 and D2, then to output information indicative of the position of the intruder, i.e., the distance away from the intruder, and the size of the intruder to the controller 43 as the measurement data D4.

The measurement data D3 include the images D1 and D2. The measurement data D4 include the distance image DT. The measurement data D4 are used to judge accurately whether the intruder detected as the object by the two-dimensional processing portion 41 is actually an intruder.

Various known algorithms are used for decision with respect to criteria for determining that the object is an intruder, i.e., intensity of a subtraction image and of a subtraction distance image.

As described above, the controller 43 controls the posture of each of the cameras 11 and 21 from side to side and up and down. Further, the controller 43 switches the setting that the images D1 and D2 taken by the cameras 11 and 21 are processed by the two-dimensional processing portion 41 or by the stereo processing portion 42.

Generally, the position of each of the cameras 11 and 21 is so controlled that each of the cameras 11 and 21 shoots a different range and faces a different direction, and each of the cameras 11 and 21 is so controlled that wide-angle zooming is achieved. In this case, the boundary portion between the images D1 and D2 taken by the cameras 11 and 21 may somewhat overlap each other. Thus, the cameras 11 and 21 shoot a wide range. During the period when each of the cameras 11 and 21 shoots a different range, the controller 43 switches the setting so that the images D1 and D2 are processed by the two-dimensional processing portion 41. Additionally, the cameras 11 and 21 may be moved so as to scan around, so that a wider range is photographed.

When an intruder is detected, for example, position control and zooming control of each of the cameras 11 and 21 are so performed that both the cameras 11 and 21 magnify the intruder for photographing the same. Stated differently, both the cameras 11 and 21 photograph ranges including the intruder, the ranges being overlapped with each other. The controller 43 switches the setting so that the images D1 and D2 are processed by the stereo processing portion 42.

More specifically, the controller 43 has mode information therein for controlling two modes, i.e., a two-dimensional measurement mode (a monocular measurement mode) and a stereoscopic measurement mode. The controller 43 switches the setting so that the images D1 and D2 are processed by the two-dimensional processing portion 41 or the stereo processing portion 42 based on the measurement data D3 output from the two-dimensional movement detection portion 412, the measurement data D4 output from the three-dimensional movement detection portion 423 and the mode information. The switching allows the setting of the two-dimensional measurement mode or the stereoscopic measurement mode. The controller 43 outputs a switching signal DC depending on the mode. As the switching signal DC, for example, the controller 43 outputs an OFF signal for the two-dimensional measurement mode and an ON signal for the stereoscopic measurement mode. The switching signal DC switches the presence or absence of the operation of the two-dimensional processing portion 41 and the stereo processing portion 42. Further, the switching signal DC may be used for switching an output destination of the images D1 and D2, an output destination of each block and the presence or absence of an operation of each block.

The controller 43 further outputs an alarm signal D5 for notifying that an intruder is detected, in accordance with the measurement data D3 or D4 output from the two-dimensional processing portion 41 or the stereo processing portion 42. Further, when the controller 43 switches from processing by the two-dimensional processing portion 41 to processing by the stereo processing portion 42, the controller 43 may output the alarm signal D5 to raise an alarm.

Based on the alarm signal D5, the output portion 44 notifies an observer that an intruder is detected by audio or image display.

Additionally, the controller 43 or the output portion 44 is so structured that the same can communicate with an external host computer or an external terminal via a LAN or other networks. The communication enables the images D1 and D2, and the measurement data D3 and D4 to be output to the host computer.

When an intruder is detected in the stereo processing portion 42, for example, the distance image DT and the reference image D1 are output. When no intruder is detected in the stereo processing portion 42, only the reference image D1 is output together with time information.

The positional control mechanisms 31 and 32 are used in addition to the pan mechanisms 12 and 22 as well as the tilt mechanisms 13 and 23 for control of the position or posture of each of the cameras 11 and 21. For example, when one of the cameras 11 and 21 detects an intruder, the pan mechanisms 12 and 22, the tilt mechanisms 13 and 23 and the positional control mechanisms 31 and 32 are so controlled appropriately that the other camera faces the intruder with the posture of the camera detecting the intruder being controlled so as to chase and photograph the intruder. On this occasion, position control is so performed that the base line connecting the two cameras 11 and 21 becomes perpendicular to the direction of the intruder in the end. At the time point when the base line becomes perpendicular to the direction of the intruder, the setting may be switched to the stereoscopic measurement mode. Thereby, the base length of each of the cameras 11 and 21 for the intruder is maximized so that the intruder can be photographed with large parallax, resulting in the stereoscopic measurement with higher degree of accuracy.

In control of the position or posture of each of the cameras 11 and 21, control may be so performed that the pan mechanisms 12 and 22 make the cameras 11 and 21 move symmetrically, and the tilt mechanisms 13 and 23 make the cameras 11 and 21 move synchronously. Thereby the mechanisms are simplified and the control is facilitated, leading to the simplified processing in the two-dimensional processing portion 41 and the stereo processing portion 42.

As described above, in the case of the control of the position or posture of each of the cameras 11 and 21, positioning is performed by the control using the pan mechanisms 12 and 22, the tilt mechanisms 13 and 23 and the positional control mechanisms 31 and 32. However, the monitoring system 1 may be so structured that positioning of each of the cameras 11 and 21 is performed mechanically at an appropriate position. The mechanical positioning is so performed that the appropriate position is, for example, a position where the optical axes of the cameras 11 and 21 are parallel to each other, a position where the cameras 11 and 21 are made both ends of a base of an isosceles triangle whose vertex is an object within a specific distance range, a position where a specific object to be monitored constantly is shot or others. A stopper or a notch can be used for the mechanical positioning, for example. The mechanical positioning mentioned above improves positional accuracy and enhances measurement accuracy without positioning control with high degree of precision.

Next, the flow of the entire operation of the monitoring system 1 is described.

(1) First, when the power source of the monitoring system 1 is turned on, the mode information inside the controller 43 is initialized to the two-dimensional measurement mode. Accordingly, in the initial condition, the controller 43 outputs an OFF switching signal DC in order to set the monitoring system 1 to the two-dimensional measurement mode.

In the embodiment described above, the images D1 and D2 are processed individually in the two-dimensional processing portion 41. However, when the cameras 11 and 21 are set to photograph the same range, two-dimensional measurement of an object may be carried out in the two-dimensional processing portion 41 using only one of the images, for example, the reference image D1. Thereby, the processing in the two-dimensional processing portion 41 is further facilitated.

(2) Next, when the previous frame image is input to the two-dimensional processing portion 41, the two-dimensional movement detection portion 412 judges whether or not an object moves in the scene using the current frame image and the previous frame image to output the decision result to the controller 43. In this case, as mentioned above, there is a possibility that even variation in illumination may be detected as movement of the object.

(3) When the reference image D1 is input to the stereo processing portion 42, the distance image DT is output to the three-dimensional movement detection portion 423 from the stereo processing portion 42. The three-dimensional movement detection portion 423 judges whether or not an object moves in the scene using the distance image DT of the current frame and the distance image DTT of the previous frame to output the decision result to the controller 43.

(4) When the mode information is the two-dimensional measurement mode, the controller 43 changes the mode information to the stereoscopic measurement mode in response to output of the measurement data D3 from the two-dimensional movement detection portion 412, the measurement data D3 indicating the presence of movement of the object. Then, the controller 43 switches so that the images D1 and D2 are processed in the stereo processing portion 42. The mode information is maintained as the two-dimensional measurement mode until the measurement data D3 are output from the two-dimensional movement detection portion 412, the measurement data D3 indicating the presence of movement of the object.

When the mode information is the stereoscopic measurement mode, the controller 43 changes the mode information to the two-dimensional measurement mode in response to output of the measurement data D4 from the three-dimensional movement detection portion 423, the measurement data D4 indicating the absence of movement of the object. Then, the controller 43 switches so that the images D1 and D2 are processed in the two-dimensional processing portion 41. When the measurement data D4 indicating the presence of movement of the object are output from the three-dimensional movement detection portion 423, the mode information is maintained as the stereoscopic measurement mode and the distance image DT is output to the output portion 44.

(5) The output portion 44 transmits the reference image D1 to the host computer along with the time information at regular intervals. When the distance image DT is output, the distance image DT is transmitted along with the reference image D1 of the same time as the distance image DT.

(6) When the host computer receives the reference image D1 or the distance image DT, the host computer records the same along with time. When the distance image DT is transmitted, the host computer raises an alarm simultaneous with recording.

According to the embodiment described above, the movement of the object is detected by comparing the image D1 or the distance image DT of the current frame and the image D1T or the distance image DTT of the previous frame. However, as shown in FIGS. 4 and 5, it is possible to compare the image D1 or the distance image DT of the current frame and an image (a background image) D1N or a distance image DTN in the initial condition or at reset. In this case, an initial image memorizing portion 411B and an initial distance image memorizing portion 422B are provided in lieu of the one-frame delay portion 411 and the one-frame delay portion 422.

The connection or operation of each of the blocks may be so controlled that the initial image memorizing portion 411B memorizes the image DIN in the initial condition, and the initial distance image memorizing portion 422B memorizes the distance image DTN in the initial condition.

More specifically, for example, when the monitoring system 1 starts, the controller 43 outputs a reset signal so that the reference image D1 is input to the initial image memorizing portion 411B. At the same time, the reference image D1 is memorized as the reference image D1N in the initial image memorizing portion 411B. Further, the stereo processing portion 42 is caused to generate the distance image DT based on the images D1 and D2 and the generated initial distance image DTN is memorized in the initial distance image memorizing portion 422B. While the monitoring system 1 is active, movement of the object is detected using the image DIN in the initial condition and the distance image DTN in the initial condition that are memorized individually.

### Second Embodiment

Next, an application example of a measurement system according to the present invention to a robot navigation system is explained below.

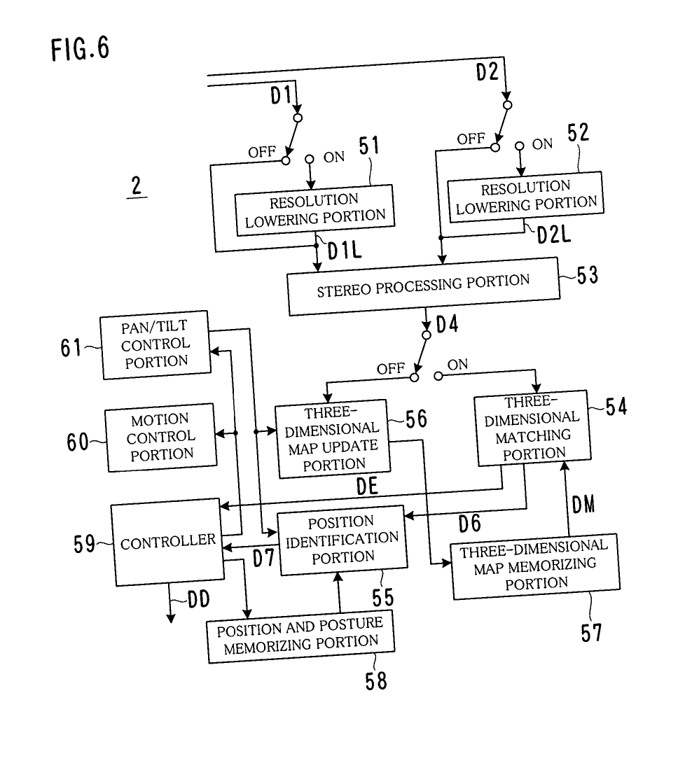

FIG. 6 shows a structure of a robot control system 2 according to a second embodiment of the present invention.

The robot control system 2 according to the second embodiment is installed inside a robot. The robot is movable back and forth from side to side by control of the robot control system 2. Moreover, the head of the robot is provided with a stereoscopic camera having a pan/tilt mechanism, and the stereoscopic camera operates in accordance with a command of the robot control system 2 inside the robot.

Here, the stereoscopic camera and the pan/tilt mechanism may be similar to the cameras 11 and 21, and the position and posture control mechanism in the first embodiment. Alternatively, the cameras 11 and 21 and the position and posture control mechanism may be simplified for use. The cameras 11 and 21 and others are omitted in FIG. 6. A driver for the position and posture control mechanism is shown as a pan/tilt control portion 61.

Referring to FIG. 6, the robot control system 2 includes resolution lowering portions 51 and 52, a stereo processing portion 53, a three-dimensional matching portion 54, a position identification portion 55, a three-dimensional map update portion 56, a three-dimensional map memorizing portion 57, a position and posture memorizing portion 58, a controller 59, a motion control portion 60 and the pan/tilt control portion 61.

The resolution lowering portion 51 or 52 reduces resolution of an image D1 or D2 output from the camera 11 or 21 to output a low resolution image D1L or D2L in which the total number of pixels is reduced. For example, image data are subtracted to reduce the resolution of the image to a half, one third or one fourth, then to output an image in which the image data are reduced correspondingly.

Similar to the case of the first embodiment, the stereo processing portion 53 performs processing for stereoscopic measurement of an object based on the images D1 and D2 or the lower resolution images D1L and D2L thereof to output measurement data D4 including a distance image DT.

The three-dimensional matching portion 54 checks the distance image (partial three-dimensional data) DT output from the stereo processing portion 53 against a three-dimensional map DM previously memorized in the three-dimensional map memorizing portion 57. Stated differently, matching is performed between the distance image DT the robot see via the cameras 11 and 21 and the three-dimensional map DM. Then, a part of the three-dimensional map DM corresponding to the distance image DT is detected to output position and posture information D6 of the distance image DT corresponding to the three-dimensional map DM. In the case of the check, the three-dimensional matching portion 54 outputs a check error signal DE to the controller 59 when the degree of the check is lower than a threshold level.

The position identification portion 55 computes a position and posture of the robot based on the position and posture information D6 output from the three-dimensional matching portion 54 and position and posture information of the cameras 11 and 21 to output position and posture information D7. The position and posture information of the cameras 11 and 21 is obtained based on information of the pan/tilt control portion 61.

The three-dimensional map update portion 56 replaces the distance image DT output from the stereo processing portion 53 with the corresponding part of the three-dimensional map DM. Thereby, the three-dimensional map DM memorized in the three-dimensional map memorizing portion 57 is updated.

The controller 59 serves as a central controller. More specifically, the controller 59 manages tasks of the robot and controls each portion of the robot based on the tasks. The controller 59 computes a movement path of the robot in accordance with the contents of the tasks, and receives necessary information from the cameras 11 and 21 appropriately, and issues a command to the motion control portion 60, the command being for forcing the robot to go the computed path.

Further, the controller 59 outputs a mode signal DD for switching between a high velocity mode and a high accuracy mode. When the mode signal DD is ON, the mode is switched to the high velocity mode and the image D1 or D2 is input to the resolution lowering portion 51 or 52, and the output from the stereo processing portion 53 is input to the three-dimensional matching portion 54.

The motion control portion 60 controls drive of wheels to control movement and turn of the robot.

The pan/tilt control portion 61 controls the line-of-sight direction of each of the cameras 11 and 21 responding to a command from the controller 59. On this occasion, posture information of each of the cameras 11 and 21 is output occasionally.

Next, the flow of the entire operation of the robot control system 2 is described.

(1) First, when the power source of the robot control system 2 is turned on, the controller 59 outputs an OFF mode signal DD to set the robot control system 2 to the high accuracy mode. The robot inputs a plurality of images D1 and D2 while scanning around with the cameras 11 and 21 controlled by the pan/tilt mechanism with the robot remaining stationary. Based on the plural images D1 and D2, a plurality of distance images DT having high degree of accuracy is generated. The distance images DT are used to prepare a three-dimensional map DM.

In the high accuracy mode, the two images D1 and D2 are input to the stereo processing portion 53 without passing through the resolution lowering portions 51 and 52, respectively. Thereby, a distance image DT having higher resolution and higher degree of accuracy is generated compared to the case where the images D1 and d2 are passed through the resolution lowering portions 51 and 52, respectively. However, the computing cost increases, leading to a low processing rate.

(2) When the robot starts to move, the controller 59 outputs an ON mode signal to switch the mode to the high velocity mode. The position and posture of the robot are calculated by checking the generated distance image DT against the three-dimensional map DM memorized in the three-dimensional map memorizing portion 57. When the robot is out of the predetermined path, the controller 59 instructs correction movement to the motion control portion 60, the correction movement being for forcing the robot to the predetermined path.

In the high velocity mode, the two images D1 and D2 are passed through the resolution lowering portions 51 and 52 respectively to input to the stereo processing portion 53. Thereby, a distance image DT having lower resolution and lower degree of accuracy is generated compared to the case where neither the image D1 nor the image D2 is passed through the resolution lowering portions 51 and 52. However, the computing cost reduces, leading to a high processing rate.

(3) Under the case of (2) mentioned above, when the controller 59 detects that the three-dimensional matching portion 54 outputs a check error signal DE, the controller 59 judges that an abnormality occurs or an environment around the robot changes, and issues an instruction to the motion control portion 60 for letting the robot stationary. Then, the controller 59 switches the mode to the high accuracy mode to perform processing similar to the case of (1) mentioned above for restructuring the three-dimensional map DM.

### MODIFICATION EXAMPLE

Next, a modification of each of the embodiments mentioned above is described with respect to a circuit for reading out the images D1 and D2 output from the cameras 11 and 21.

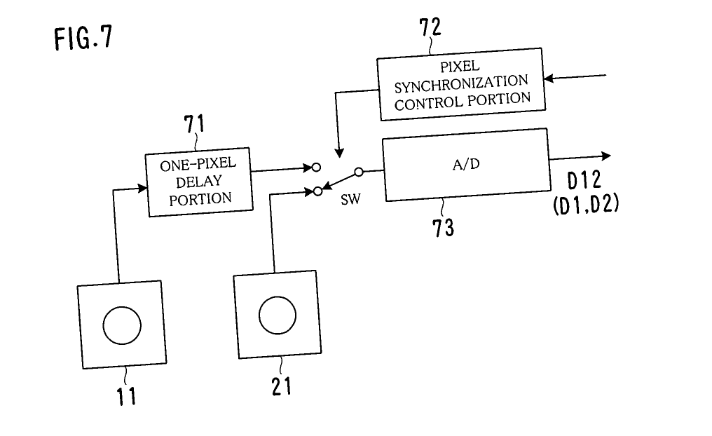

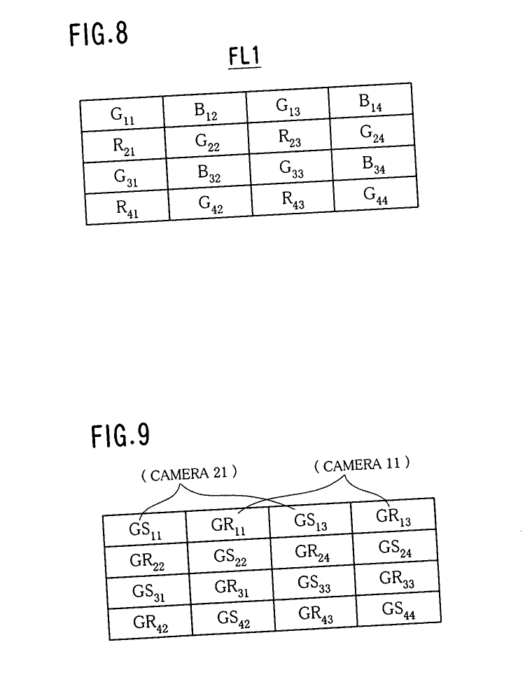

FIG. 7 is a block diagram showing a portion of an image input circuit, FIG. 8 shows a part of pixels of an image pickup device and FIG. 9 shows an example of a state in which a signal is allocated to each pixel.

A color CCD is commonly used as an image pickup device in each of the cameras 11 and 21. An inexpensive camera often has a CCD in which a color filter having any one of three primary colors of red, green and blue is applied to each pixel. Such an entire color filter sometimes may be referred to as a color mosaic filter. The typical example of the color mosaic filter is an RGB Bayer filter FL1 shown in FIG. 8. The use of the RGB Bayer filter FL1 permits representation of one pixel of each of the images D1 and D2 of an object by means of four pixels including two green pixels, one red pixel and one blue pixel.

Meanwhile, it is economical that a color image is used as an image for recording, and a luminance image is used as an image for stereoscopic measurement. The reason is that the use of luminance components is the most effective for correspondence in the stereoscopic measurement, and the use of color components increases a computing cost with low efficiency.

Therefore, when measurement is conducted by the stereoscopic measurement mode, luminance components are extracted from the CCD of each of the cameras 11 and 21 to be interlaced for each pixel, then to be output. In order to realize this operation, the circuit is provided with a one-pixel delay portion 71 for delaying one pixel of the output from the camera 11 and a pixel synchronization control portion 72 for controlling the pixels synchronously.

More specifically, the one-pixel delay portion 71 delays one pixel of an RAW image whose pixel data are serially output from the CCD of the camera 11 as a referred camera in raster order, the RAW image having a Bayer arrangement. The switch SW is so switched that a green pixel is output from the camera 11 at the timing when a red pixel or a blue pixel is output from the CCD of the camera 21 as a reference camera. The pixel synchronization control portion 72 controls timing for the switching. As shown in FIG. 9, the switch SW outputs image signals from the CCD of the camera 11 and image signals from the CCD of the camera 21 alternately. The output image signals are quantized using one A/D converter.

Referring to FIG. 9, image components of green (GS) of the reference camera 21 and image components of green (GR) of the referred camera 11 are output alternately.

Thereby, it is possible to capture an image 12 in which the green pixel components of the cameras 11 and 21 are arranged alternately by a single system line. The captured image D12 is memorized in an appropriate memory. The designation of an address allows the two images D1 and D2 to be read out separately. Thus, image data of pixels corresponding to only a color filter with a particular color in the CCD of each of the cameras 11 and 21 are used.

Thereby, capture of images from the cameras 11 and 21 is speeded up in the stereoscopic measurement mode. Further, such a structure permits a color image (a Bayer arrangement RAW image) of the reference camera 21 to be read out of the CCD without any change in the two-dimensional measurement mode.

According to the embodiments described above, in a robot and a monitoring system, an environmental change and object movement are triggered to switch between a two-dimensional measurement mode and a stereoscopic measurement mode, and therefore optimum measurement can be conducted with a low cost structure.

Further, position control is so performed that photograph ranges of the cameras 11 and 21 are different from each other. Then, position control is so performed that both the cameras 11 and 21 conduct stereoscopic measurement when an intruder or the like is detected. Thereby, it is possible to achieve wide-ranging monitoring and determination of the presence or absence of an intruder with high degree of accuracy.

According to the embodiments described above, the positions of the cameras 11 and 21 are mainly controlled by the pan mechanisms 12 and 22 as well as the tilt mechanisms 13 and 23, respectively. However, the relative positional relationship between the cameras 11 and 21 may be fixed. On this occasion, the positional relationship between the cameras 11 and 21 may be fixed, and besides, the positional control mechanisms 31 and 32 or others may control the position of the whole of the cameras 11 and 21. For example, in the robot control system 2 according to the second embodiment, the positional relationship between the two cameras is fixed. The two cameras are made a group of cameras, the whole of which is controlled so as to be panned and tilted. The mode is switched between the two-dimensional measurement mode and the stereoscopic measurement mode, similar to the case of the first embodiment. In this case, only an image photographed by one of the cameras is used for two-dimensional measurement. However, two images photographed by both the cameras can be used as two-dimensional images. In the case of stereoscopic measurement, correspondence between an image photographed by one of the cameras and an image photographed by the other is conducted.

In the embodiments described above, the cameras 11 and 21 are placed in the lateral direction (the horizontal direction) side-by-side. However, the cameras may be placed in the longitudinal direction (the vertical direction) or placed diagonally. It is also possible to use three or more cameras. Each portion of the monitoring system 1 or the robot control system 2 can be realized using a CPU, a memory and others in terms of software, or using a hardware circuit or in combination thereof.

In the foregoing embodiments, structures, circuits, shapes, dimensions, numbers and processing contents of each part or whole part of the monitoring system 1 or the robot control system 2 can be varied as required within the scope of the present invention. The present invention can be used for various applications other than the monitoring system and the robot control system.

What is claimed is:

1. A measurement system for measuring an object based on images obtained by plural cameras, the system comprising:
a positional control portion for controlling positions of the cameras to change photographing directions of the cameras;
a two-dimensional measurement portion for conducting two-dimensional measurement of the object based on the image of the object, the image being obtained by at least one of the cameras;
a stereoscopic measurement portion for conducting stereoscopic measurement of the object based on the images of the object, the images being obtained by the cameras; and
a switching portion for switching between the two-dimensional measurement portion and the stereoscopic measurement portion to perform an operation.

2. The measurement system according to claim 1, wherein the two-dimensional measurement portion conducts two-dimensional measurement based on the image obtained by only one of the cameras.

3. The measurement system according to claim 1, wherein the cameras allow for photographing directions differing from each other, and the cameras are controlled so as to photograph ranges differing from each other and to face directions differing from each other when the two-dimensional measurement is conducted.

4. The measurement system according to claim 1, wherein the cameras allow for photographing directions differing from each other, and the positions of the cameras are so controlled that the cameras photograph an overlapping range when the stereoscopic measurement is conducted.

5. The measurement system according to claim 1, wherein
the positional control portion controls the positions of the cameras so that the cameras photograph ranges differing from each other and face directions differing from each other when the two-dimensional measurement portion conducts two-dimensional measurement, and controls the positions of the cameras so that the cameras photograph an overlapping range when the stereoscopic measurement portion conducts stereoscopic measurement, the overlapping range including the object, and
the switching portion switches to operate the two-dimensional measurement portion in an initial condition, and switches to operate the stereoscopic measurement portion when the two-dimensional measurement portion detects a moving object.

6. The measurement system according to claim 1, wherein the positional control portion controls the entire position and posture of the cameras.

7. The measurement system according to claim 1, wherein the positional control portion allows for control of the position and posture of each of the cameras and the cameras are controlled so as to move symmetrically.

8. The measurement system according to claim 1, wherein the positional control portion allows for control of the position and posture of each of the cameras and the cameras are controlled so as to move synchronously.

9. The measurement system according to claim 1, further comprising an alarm output portion for raising an alarm based on an alarm signal output from the switching portion.

10. The measurement system according to claim 9, wherein the alarm output portion raises the alarm when the switching portion switches from processing in the two-dimensional measurement portion to processing in the stereoscopic measurement portion.

11. The measurement system according to claim 1, wherein the stereoscopic measurement portion includes a portion for reducing resolution of the images, and switches between generation of three-dimensional data with high resolution and generation of three-dimensional data with low resolution appropriately to conduct stereoscopic measurement.

12. The measurement system according to claim 1, wherein each of the cameras includes an image pickup device in which a color filter having any one of three primary colors is arranged for each pixel, and when image data obtained by the cameras are processed, image data of pixels corresponding to only a color filter with a particular color in the image pickup device of each of the cameras are used.
